(19) United States
(12) Patent Application Publication
(10) Pub. No.: US 2009/0309829 A1
(43) Pub. Date: Dec. 17, 2009

(54) SIMPLE MULTIDIRECTIONAL KEY FOR CURSOR CONTROL

(75) Inventor: Hwai Kiang Tan, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/373,754

(22) PCT Filed: Jul. 13, 2007
(86) PCT No.: PCT/IB07/52799

§ 371 Date: Jan. 14, 2009

(30) Foreign Application Priority Data
Jul. 19, 2006 (EP) 06117453.8

(51) Int. Cl. G09G 5/00

(52) U.S. Cl. 345/156

(57) ABSTRACT

A multidirectional key is operative to press a specific one of multiple contacts, depending on the direction wherein the key's button disc is being moved. The fingers are projections extending from a ring, the combination being made out of sheet metal, and bent out of the plane of the disc to engage with the button when the latter is moved. As a result, the multidirectional key has a very simple configuration and is inexpensive to manufacture.

### FIELD OF THE INVENTION

The invention relates to an apparatus having a user input with a multidirectional key. The invention also relates to a multidirectional key.

### BACKGROUND ART

There exist various embodiments of multidirectional input devices for moving a cursor, a highlight or another indicium (hereinafter jointly referred to as: cursor) on a display monitor. These embodiments include the computer-mouse and the joystick. The mouse or joystick can be implemented as a separate device or, alternatively, as being physically integrated in a data processing apparatus or in another accessory. Examples of such apparatus include a handheld remote control, a laptop computer or a palmtop computer. An example of an accessory is a keyboard. The control mechanism of an integrated mouse can be implemented as a multidirectional key using a pressure contact design, or force-sensitive resistors (FSR). In the FSR implementation, the user uses his/her thumb to apply a pressure to a fixed-position disc to activate the mouse movement. For the integrated joystick, the user uses the thumb to roll the anchored stick for control of the cursor movement.

Known examples of multidirectional keys are briefly discussed below.

JP2004031177 discloses a multidirectional input key penetrating an annular hole in the top face of a housing. The user can slide the key within the plane of the top, its travel being limited by the wall of the hole. The key sits on a flexible key seat that engages with fixed positions in the housing so as to drive the key back to a neutral position upon the user releasing the key. The bottom of the key seat is profiled and engages with a membrane switch configuration that has four contacts, one for each main direction. Sliding the key in a specific direction causes the profiled bottom to close the associated one of the contacts.

JP2004171924 discloses a multidirectional input key that can slide within a housing. The key has a lower part that is held in a neutral position between with two flexible, electrically conductive elements arranged in the plane of the lower part. Pushing the key in a certain direction deforms one of the elements against the wall of the housing. Each element can touch one of two electric contacts in the wall. Which one of the contacts is being touched depends on the element's deformation, which in turn is governed by the direction wherein the key is being pushed.

Further examples of multi-directional keys are being disclosed in JP59206932, JP09134248; and JP5204539.

### SUMMARY OF THE INVENTION

It is one of the objects of the invention is to provide an alternative, simple and rugged design for a multidirectional key, especially suitable for low-cost applications, such as in inexpensive mass-produced remote control devices.

The inventor therefore proposes an apparatus as specified in claim 1 and a multidirectional key for use in such an apparatus. Advantageous embodiments are being addressed in the dependent claims. The invention is of particular interest for remote control devices, laptop computers, palmtop computers, mobile phones and other handhelds.

### BRIEF DESCRIPTION OF THE DRAWING

The invention is explained in further detail, by way of example and with reference to the accompanying drawing wherein:

FIG. 1 is a diagram of an apparatus in the invention;

FIGS. 2 and 3 illustrate an example of the multidirectional key in the invention in operational use; and

FIG. 4 shows an implementation of an element in the key.

Throughout the figures, same reference numerals indicate similar or corresponding features.

### DETAILED EMBODIMENTS

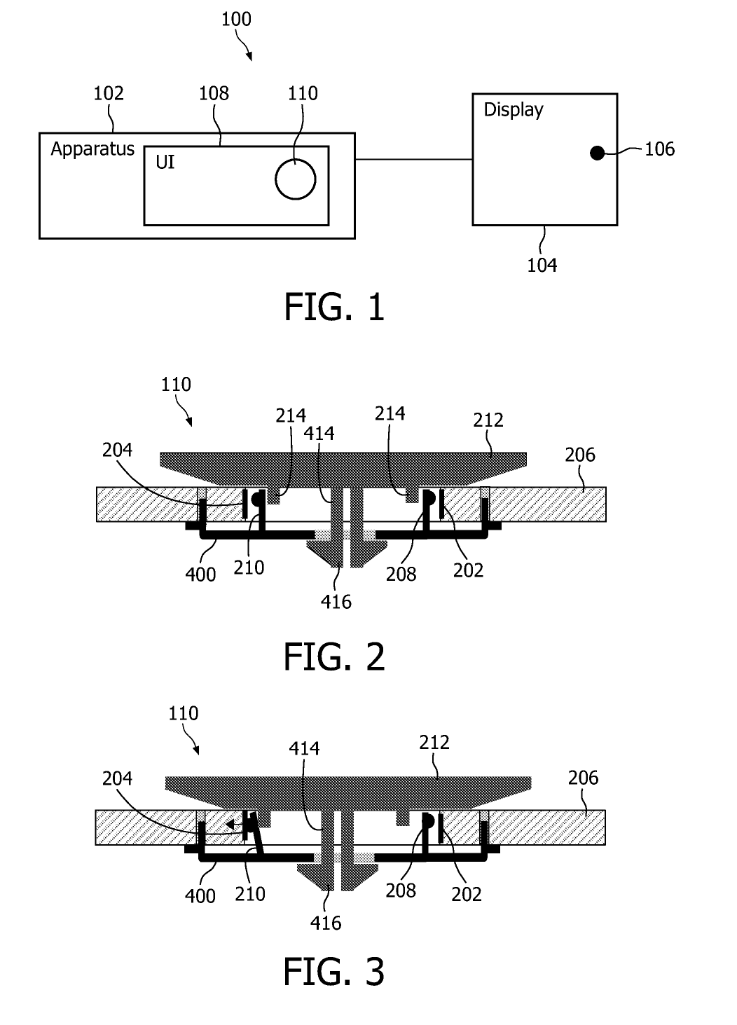

FIG. 1 is a diagram of a system 100 in the invention, comprising an apparatus 102, here a remote control device, and a data processing system having a display monitor 104. Remote control 102 is operative to control, among other things, the movement of a cursor 106 on display monitor 104. Such systems are known in the art and are not discussed in further detail here. Remote control 102 has a user-interface 108 that accommodates a multidirectional key 110 for control of cursor 106. Key 110 is moveable relative to a housing of remote control 102 for converting a movement of the key in a specific direction into a signal representative of this specific direction.

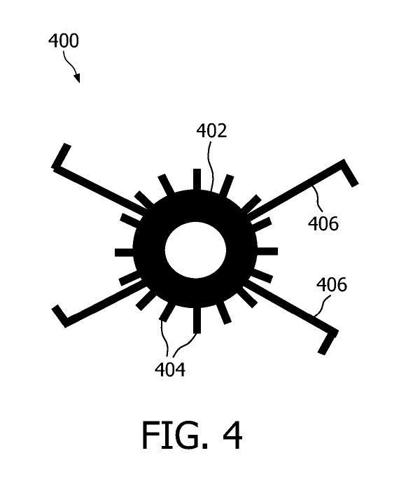

FIGS. 2 and 3 illustrate an embodiment of key 110 in operational use. Key 110 comprises a plurality of contacts 202, 204 in a first plane defined by a printed circuit board (PCB) 206. Key 110 further comprises a plurality of fingers 208, 210, each respective one of fingers 208, 210 facing a respective one of contacts 202, 204. Key 110 also has a component 212 moveable in parallel with PCB 206 and having a part 214 between fingers 208, 210. The features with reference numerals 400, 414 and 416 concern implementation details discussed further below with reference to FIG. 4. As shown in FIG. 3, part 214 is configured for forcing a specific one of the fingers, here finger 210 against facing contact 204 dependent of the direction wherein component 212 is being moved. Fingers 208 and 210, as well as contacts 202 and 204, comprise an electrically conductive material. Fingers 208 and 210 are galvanically connected to each other and are grounded. Alternatively, fingers 208 en 210 can be connected to each other and to one or more other electrical components (not shown). Contacts 202 and 204 in PCB 206 carry a nonzero voltage so that there is a potential difference between contacts 202, 204 on the one hand, and grounded fingers 208, 210 on the other hand. Upon finger 210 and contact 204 touching each other, a current starts to flow between contact 204 and finger 210. The direction of movement of component 212 can therefore be determined by means of identifying the relevant one of contacts 202 and 204 that is conducting an electric current.

Note that if the fingers are made out of an elastic or springy material, component 212 will more easily assume a neutral position when released, owing to the restoring force exerted on part 214 by the finger previously forced against its facing contact, see finger 210 in FIG. 3.

FIG. 4 illustrates a simple and inexpensive implementation for creating fingers 208 and 210. In FIG. 4 is shown an element 400 made out of sheet metal and having a particular contour. Element 400 is shaped like a ring 402 with projections 404 extending radially from the outer perimeter of ring 402, as well as further projections 406 extending from ring 402. The outer portions of projections 404 are to be bent out of the plane of ring 402 so as to form the fingers, such as fingers 208 and 210 in FIGS. 2 and 3. Further projections 406 are used to anchor element 400 to PCB 206 and to serve as electrical connection to ground as illustrated in FIGS. 2 and 3, or to one or more other electrical components (not shown). Note that component 212 has a shaft 414 extending through ring 402 of element 400. Shaft 414 is narrower than the inner diameter of ring 402, thus serving to restrict lateral movement (sideways in FIGS. 2 and 3) of component 212. Also note that shaft 414 has a bottom part 416 that is wider than the inner diameter of ring 402, and that the top part of component 212 is wider than the hole in PCB 206. This restricts the axial movement (up or down in FIGS. 2 and 3) of component 212. If component 212 is made from a plastic material that easily deforms when heat is applied, key 110 is extremely simple to assemble by sticking element 400 into the bottom of PCB 206, sticking component 212 through the holes in PCB 206 and in element 400, and deforming the bottom part of shaft 414 to form part 416. Other implementations are feasible, e.g., a configuration wherein component 212 and element 400 can be connected through snap-fitting element 400 over part 416 (part 416 can then be deformed elastically to a cross-section small enough to pass through the hole of inner diameter of ring 402), or connecting component 212 and element 400 with a screw or with glue, etc.

1. An apparatus comprising a multidirectional key in a housing for converting a movement into a specific one of multiple directions into a signal representative of the specific direction, wherein the key comprises:
a plurality of contacts in a first plane;
a plurality of fingers, each respective one of the fingers facing a respective one of the multiple contacts;
a component moveable in parallel with the plane and having a part between the fingers, wherein the part is configured for forcing a specific one of the fingers against the facing one of the contacts in dependence on the direction wherein the component is moved.

2. The apparatus of claim 1, wherein the fingers and the contacts comprise a conductive material and wherein the fingers are galvanically connected to each other.

3. The apparatus of claim 2, wherein the fingers comprise strips bent out of a second plane of a single sheet of the conductive material.

4. The apparatus of claim 1, comprising at least one of: a remote control device, a laptop computer, a palmtop computer, and a mobile phone.

5. A multidirectional key for use in the apparatus of claim 1.
